(19) United States
(12) Patent Application Publication
(10) Pub. No.: US 2013/0013389 A1
(43) Pub. Date: Jan. 10, 2013

(54) MOBILE VOUCHER SYSTEM AND METHOD

(75) Inventors: Antonio Vitti, Oakland, CA (US); John Vitti, San Francisco, CA (US)

(73) Assignee: Mobile Spinach, Inc., San Mateo, CA (US)

(21) Appl. No.: 13/178,461

(22) Filed: Jul. 7, 2011

(51) Int. Cl. G06Q 30/00

(52) U.S. Cl. 705/14.35; 705/14.38

(57) ABSTRACT

A system and method for providing mobile vouchers are provided. The mobile voucher system provides provable in-store redemption, city wide vouchers, cross selling of deals at time of redemption and partial redemption of vouchers and proximity based pricing.

### APPENDICES

Appendix A (9 pages) show more details of the merchant system of the mobile voucher system; and

Appendix B (13 pages) show more details of the publisher system of the mobile voucher system, both of which are incorporated herein by reference.

### FIELD

The disclosure relates to a system and method for generating vouchers for a user using a mobile device and in particular to a mobile voucher system that provides provable in-store redemption, city wide vouchers, cross selling of vouchers, partial redemptions and proximity based pricing.

### BACKGROUND

Systems exist that generate and provide paper or virtual coupons on a consumer. For example, Catalina Marketing Corporation provides a system in which coupons, based on the purchasing of products such as at grocery store, are printed on a receipt that is then provided to the consumer. In more detail, Catalina Marketing Corporation analyzes shoppers' purchases at large national retailers such as supermarkets, pharmacies and other mass merchandise stores. It then presents these shoppers with in-store coupons printed on the back of their paper store receipt that are related to their previous shopping history in that store. While this provides a great mechanism to provide the consumer additional coupons, this system has a few drawbacks. First, it limited to paper delivery on printed receipts and is therefore not digital or interactive. Second, these coupons are limited to the same store of the purchase. Third, these coupons are targeted only to bring consumers back to the same store, and not necessarily for a complimentary shopping experience at another vendor. Fourth, these are just coupons, and are not necessarily the most compelling offers to the consumers and are typically tied to a manufacture's product, with a number of purchasing restrictions. And fifth, there is no way to interactively transact in real time with the coupons by purchasing on a digital device. And sixth and finally, there is no way to tie the shopping patterns to a particular consumer over time and track that consumer's purchase and redemption history across multiple visits.

Systems also exist in which a group of consumers are able to aggregate their demand for a particular product/service at a particular price. In these systems, the merchant agrees to create a deal and the deal is presented to consumers. Once a sufficient number of consumers indicate their interest in the particular product/service at the particular price, the deal for the particular product/service at the particular price occurs. When the merchant of the particular product/service accepts the deal, each consumer can purchase the particular product/service at the particular price from the merchant. An example of such as system is the system provided by Tippr, Inc. Tippr also provides accelerated deals in which, as more people buy a deal for a product/service, each consumer is giving a bigger discount. Tippr.com LLC, is an online local daily deal provider that depends on a certain minimum number of users signing up before a deal is available to purchase from a local merchant. Tippr increases the discount offered to consumers as more consumers buy into the deal. However, Tippr does not have an automated way of signing up merchants, cannot prove in-store redemption, cannot perform proximity based pricing, and does not allow for consumer created deals.

Thus, it is desirable to provide a mobile voucher system and method that overcomes the above limitations of the existing systems and it is to this end that the disclosure is directed.

### BRIEF DESCRIPTION OF THE DRAWINGS

FIG. 1 illustrates an implementation of a mobile voucher system;

FIG. 2 illustrates an example of a user interface of a consumer computing device mobile voucher application;

FIG. 3 illustrates an example of the user interface of a consumer computing device digital voucher issued by the mobile voucher system;

FIG. 4 illustrates a method for proving in-store redemption of the mobile vouchers using the mobile voucher system;

FIG. 5 illustrates an example of a geographic area wide voucher with partial redemption;

FIGS. 6A-C illustrate an example of a partial redemption using the mobile voucher system;

FIG. 7 illustrates an example of a user interface of the digital voucher with a redemption code.

### DETAILED DESCRIPTION OF ONE OR MORE EMBODIMENTS

The disclosure is particularly applicable to a mobile voucher system in which one or more smartphones (Apple iPhone, Android OS based phones, etc.) are used to interact with a mobile voucher system in a client/server type architecture over the Internet and it is in this context that the disclosure will be described. It will be appreciated, however, that the system and method has greater utility since it can be implemented using other mobile devices, may be implemented using other computer architectures and may be used for other mobile type applications that are within the scope of this disclosure.

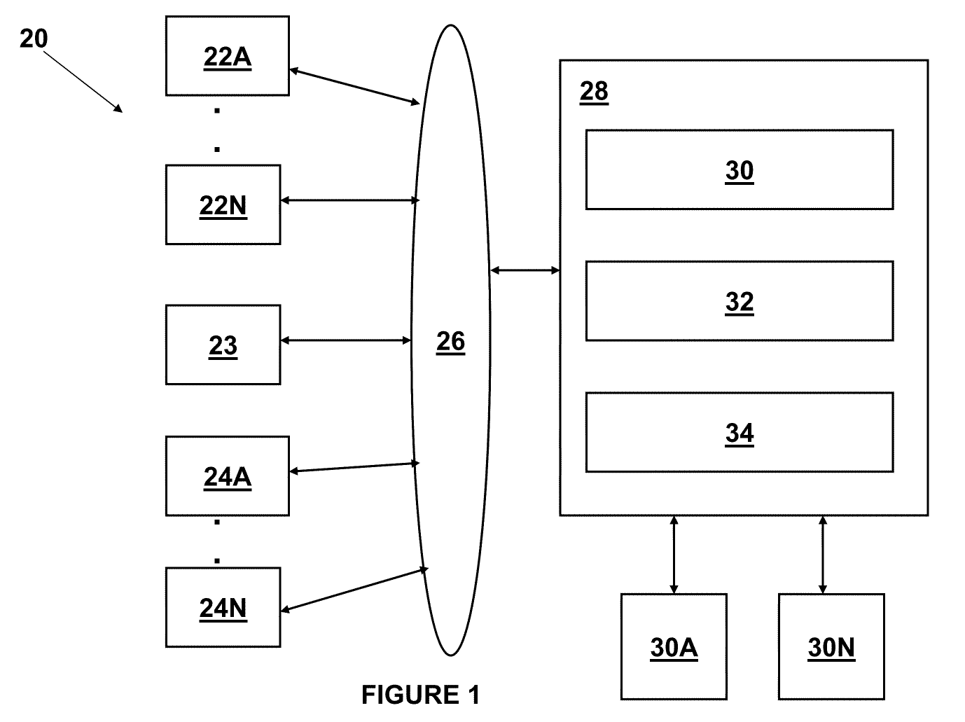

FIG. 1 illustrates an implementation of a mobile voucher system 20. The mobile voucher system 20 may have one or more consumer computing devices 22A-22N, one or more publisher systems 23 and one or more merchant systems 24A-24N that communicate with and interact over a link 26 to a mobile voucher unit 28. The one or more consumer computing devices 22A-22N may each be a processing unit based device with sufficient processing power, memory capacity and wired/wireless connectivity to communicate with and interact over the link 26 to the mobile voucher unit 28 as described below in more detail. For example, each consumer computing device may be a smartphone mobile device (such as an Apple® iPhone®, a RIM® Blackberry® device, Windows Phone 7, an Android operating system-based device and the like), a laptop computer, desktop personal computer (PC), a tablet computer (such as the Apple® iPad® and the like) and other devices that are capable of communicating with and interacting over the link 26 to the mobile voucher unit 28. The one or more publisher systems 23 may each be a processing unit based device with sufficient processing power, memory capacity and wired/wireless connectivity to communicate with and interact over the link 26 to the mobile voucher unit 28 as described below in more detail. For example, each publisher system may be one or more server computers, a personal computer, a laptop computer, a tablet computer, a smartphone and the like. The one or more merchant systems 24A-24N may each be a processing unit based device with sufficient processing power, memory capacity and wired/wireless connectivity to communicate with and interact over the link 26 to the mobile voucher unit 28 as described below in more detail. For example, each merchant system may be one or more server computers, a personal computer, a laptop computer, a tablet computer, a smartphone and the like. Each merchant system also may be just a facsimile machine that allows the merchant to interact with the mobile voucher unit 28. The link 26 may be a wireless or wired link that may be a computer network, a cellular network, a cellular digital data network, an internet-based network, a communications network and the like. The mobile voucher unit 28 may be one or more server computers that execute the code to implement the functions and operations of the mobile voucher unit 28, one or more cloud based resources that execute the code to implement the functions and operations of the mobile voucher unit 28 or one or more hardware devices that implement the functions and operations of the mobile voucher unit 28. In one embodiment, each consumer computing device is a smartphone device, each publisher system and each merchant system is one or more server computers, the link is the Internet and the mobile voucher unit 28 is one or more server computers. Although the system in FIG. 1 has a client/server type architecture, the system also may be implemented using a SaaS architecture, a cloud based architecture and the like since the system is not limited to any particular system architecture, type of consumer computing device, type of publisher or merchant system or link.

In one implementation, each consumer computing device may have a browser application that is capable of communicating and interacting with the mobile voucher unit 28. In other implementations, each consumer computing device may have an app (a stand alone app or an app that operates inside of another app) that is capable of communicating and interacting with the mobile voucher unit 28. The publisher system(s) and merchant system (s) may similarly have browser applications or apps that is capable of communicating and interacting with the mobile voucher unit 28.

In operation, each consumer computing device, using the browser or app, may indicate an interest in a syndicated deal/voucher, purchase a voucher from the mobile voucher unit 28 and then redeem the voucher at a merchant who is a member of the mobile voucher unit 28. Each publisher system is a system that a person/business user, who wishes to generate an app (game application, commerce application, etc.) that embeds the mobile voucher app, to submit their app into which the mobile voucher app from the mobile voucher unit 28 may be integrated. Each merchant system allows the merchant to interact with the mobile voucher unit 28 and participate in the mobile vouchers that are generated by the mobile voucher unit 28. More details of the merchant system are provided in Appendix A which is incorporated herein by reference. Furthermore, more details of the published system are provided in Appendix B which is incorporated herein by reference.

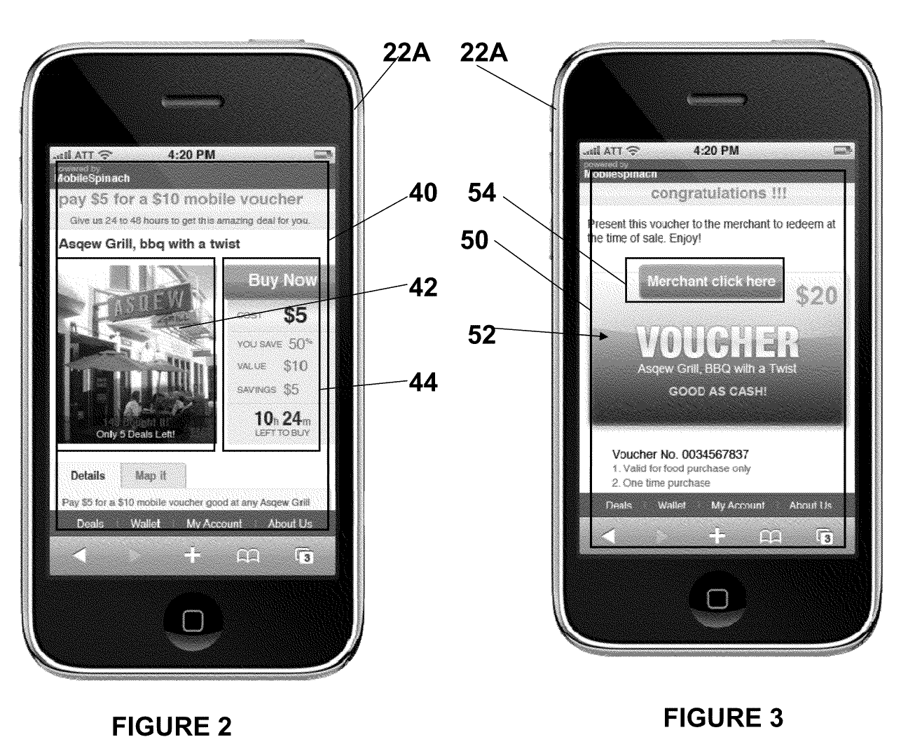

FIG. 2 illustrates an example of the user interface 40 of a consumer computing device 22A mobile voucher application and FIG. 3 illustrates an example of a user interface 50 of the consumer computing device 22A digital voucher issued by the mobile voucher system. As shown in FIG. 2, the user interface 40 displays the voucher deal to each user who has the consumer computing device 22A. Each mobile voucher user interface 40, as shown in FIG. 2, has a merchant photo/image/status portion 42 that shows the merchant photo/image for the particular deal/voucher and a status for the particular voucher when the user views the voucher (a number of deals already bought (such as 148 as shown in FIG. 2 and a number of deals/vouchers left (such as 5 in the example)). Each mobile voucher user interface 40, as shown in FIG. 2, also has a voucher details portion 44 that contains various information about the voucher/deal. For example, the voucher details portion 44 may have a “Buy Now” user interface element so that that user can buy the voucher (provisionally if the deal threshold has not been met, or if the deal has not yet been accepted by the merchant), the saving percentage associated with the voucher, the value of the voucher/deal and the savings associated with the voucher and a time left to buy the particular voucher. Once the user has bought the voucher/deal which has been approved by the particular merchant, the digital voucher user interface 50 shown in FIG. 3 appears on the device 22A. The digital voucher user interface 50 may include a digital voucher 52 that contains information about the voucher and terms and conditions of the purchased voucher. The digital voucher user interface 50 also may include a redemption user interactive interface element 54 that allows the merchant to prove redemption of the voucher.

Using the mobile voucher system, one or more consumer(s) “provisionally buys” a deal/voucher for a specific price and discount from m.MobileSpinach.com's mobile phone based application (which may or may not be embedded in other 3^{rd} party smartphone native applications, mobile web application (or web based desktop application at www.mobilespinach.com or other 3^{rd} party websites). For the created deals, Mobile Spinach is the merchant of record. Typically the deals are in the form of pay $10 for a $20 voucher that you can use to buy $20 worth of any product or service at the specific local merchant. An example of a created deal is shown in FIG. 2 that is an example of the user interface of a mobile device mobile voucher application. During the creation of sufficient consumer interest in the created deal, each consumer'(s) credit card is “held”/stored but not charged for deals that do not have sufficient interest yet and/or are still pending approval from a local merchant. For deals that are already approved, the consumer's credit card is charged right away. The mobile voucher manager 32 continues to sell the deal/accrue customer demand until it reaches a deal threshold (that may be a certain number of 1) deals sold or 2) $ amount of deals sold) and the thresholds are determined by the mobile voucher manager 32. These values are set internally by the mobile voucher manager. Factors that affect these values are the type of merchant, the rate at which the deal is being bought by consumers, the discount being offered, the day of the week, and whether or not this merchant has been featured by the mobile voucher manager before, and the related values that other similar merchants have agreed to in the past. For example, if previously fitness clubs typically are comfortable accepting 100 deals sold totally $2000 in value, then the mobile voucher manager would continue to sell the deal until 100 units have been sold and $2000 of revenues have been collected from the consumers. Once the deal threshold has been reached for a particular deal, the merchant is then automatically contacted by the mobile voucher manager 32 and asked if they would like to accept these customer(s) and the deal that was offered to the customer(s). The mobile voucher manager 32 can contact the merchant via automated email and/or fax and/or phone. If the merchant agrees to the deal/voucher, the deal goes live and the previously stored/held consumer(s) credit cards are now charged for the amount of the deal specified and the consumer receives a digital voucher and the funds from the consumer(s) go into a Mobile Spinach bank account. The mobile voucher manager 32 continues to sell the deal to new consumers if the merchant approves that, or it will stop selling it to new consumers and just fulfill the ones already sold if the merchant only agrees to that. If the merchant declines to accept the created deal, then the deal is revoked and the consumer's credit cards are not charged the money for the deal is no longer held on the credit card. In the mobile voucher system, each consumer is notified of the outcome of the deal (whether accepted or declined) via email or can see the status of the deal on the Mobile Spinach application the next time they log back in. Now, a method for providing in store redemption implemented using the mobile voucher system is described in more detail.

In-Store Redemption

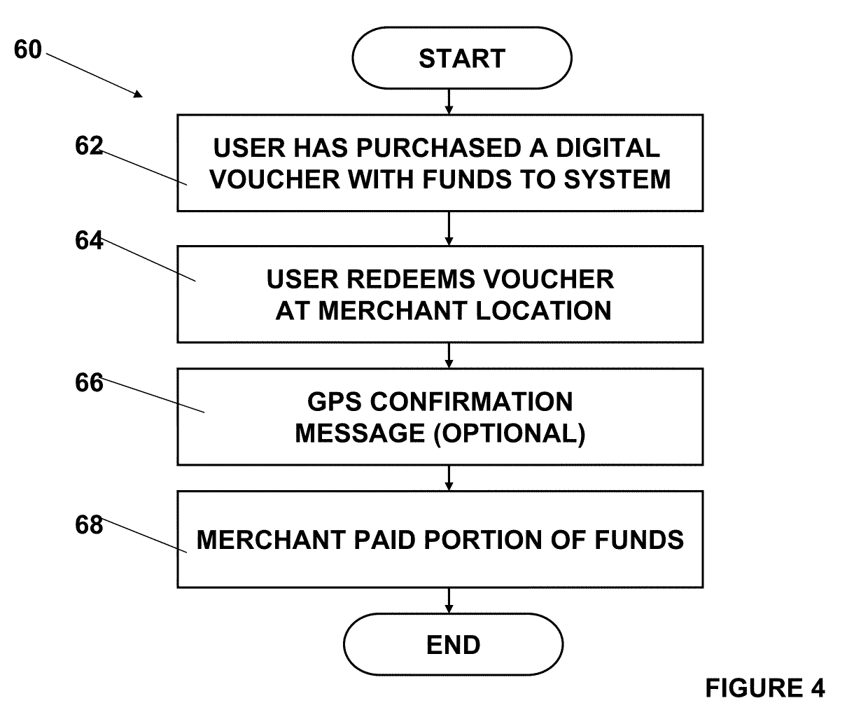

FIG. 4 illustrates a method 60 for proving in-store redemption of the mobile vouchers using the mobile voucher system. The method accomplishes in-store redemption without any point of sale hardware or software as described below. During the method, a consumer has purchased a digital voucher with funds (62) that are sent to the mobile voucher system who acts as escrow as described below. In more detail, the consumer(s) “provisionally buys” a deal for a specific price and discount as described above. When each consumer “provisionally buys” the deal/voucher, each consumer's credit card is “held”/stored but not charged for deals that are still pending approval from the merchant (whereas, for deals that are already approved by the merchant, the consumer's credit card is charged right away.) As described above, if the merchant accepts the deal/voucher, the deal goes live, the previously stored/held consumer credit cards are each now charged for the amount of the deal and each consumer receives a digital voucher. The funds from the consumer go into the bank account of the mobile voucher system that then acts as a escrow as described below.

Each user/consumer is told to click a “redeem” button on the voucher in the physical presence of the merchant (64) when each user is ready to use the voucher and redeem the offer (the merchant can press the redeem user interface (shown in FIG. 3) on the consumer's phone as well). When the user or merchant presses the “redeem” user interface an optional additional GPS location request authorization (66) may pop up (when the consumer computing device has GPS capabilities) to further confirm that the consumer is physically in or near the merchant to further validate that the consumer is at the merchant, although this is not necessary to prove redemption (this helps to prevent accidental unintended redemptions of the voucher by the consumer and provides the mobile voucher system with additional geographic data patterns on the consumer which can be used for future deal targeting). In more detail, the GPS information may be sent back to the mobile voucher unit that can determine that the consumer is physically in or near the merchant to further validate that the consumer is at the merchant.

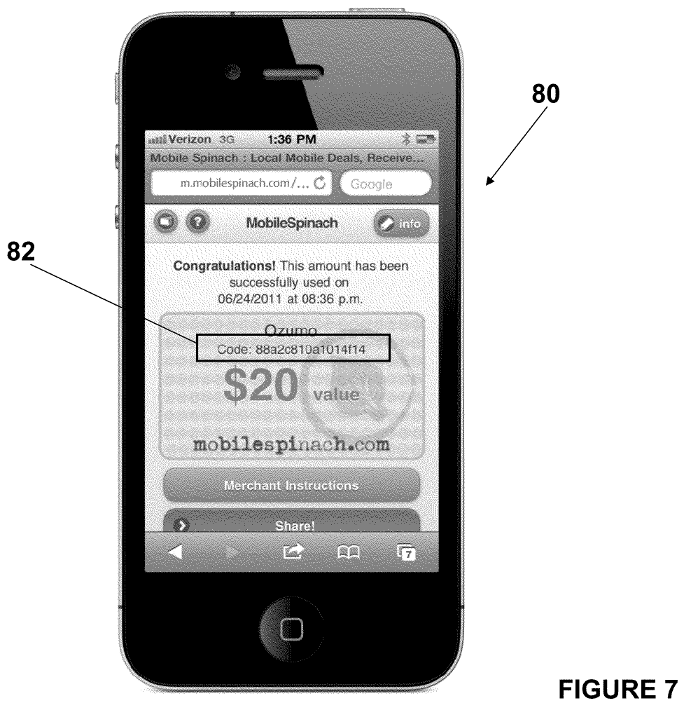

Once the “redeem” user interface element is pressed, then the voucher is permanently marked “redeemed” and the option to redeem it is removed, and a redemption code with a timestamp of when it was redeemed is permanently displayed on the voucher. FIG. 7 illustrates an example of a user interface of the digital voucher 80 with a redemption code 82 that is part of the digital voucher.

At this point, and only at this point, the merchant is paid their portion of the funds (68) that the mobile voucher system received from the consumer via automated PayPal or Automated Clearing House (ACH) (in practice the Merchant may receive their funds at the end of a monthly payment cycle). In one implementation, the merchant receives a predetermined percentage, such as for example 50%, of the gross consumer proceeds paid to the mobile voucher system from the consumer for that deal. In another implementation, the mobile voucher system (and in particular the mobile voucher manager 32) may elect to pay a portion of the consumer proceeds to the merchant in advance of the consumer redeeming a deal, and pay the remainder only after the time of redemption. In the redemption, the consumer may have also paid the merchant additional payment directly if they purchased goods or services in excess of the voucher nominal value at the time of the visit and these funds go directly to the merchant.

By essentially acting as “escrow”, the mobile voucher system is able to “prove” redemption entirely on the consumer computing device, by appropriately aligning economic incentives: i.e., the consumer doesn't want to press “redeem” until they have to (otherwise they would “lose” that voucher), and the merchant wants to have that redeem button pressed so they can get paid. Because these two parties have opposing financial incentives when they enter into a transaction, there is a bona fide settlement. The mobile voucher system acts as a settlement intermediary and releases the Merchant's share of the funds to the Merchant only at the time of this transaction. While the in store redemption requires a web enabled and connected consumer computing device, it does not involve paper at all or any separate POS systems for the Merchant.

Geographical Area Wide Vouchers

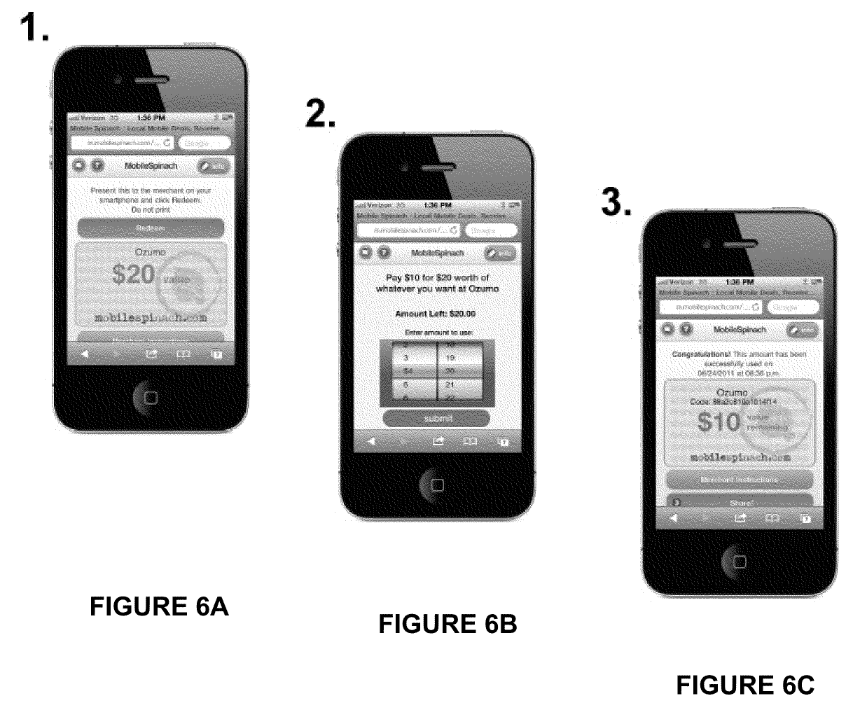

In addition to the vouchers/deals that are for a particular merchant as described above, the mobile voucher system may also provide a city wide voucher (or neighborhood or geographic region wide voucher) and can be purchased by the consumer, such as a ‘Mobile Spinach Anywhere’ San Francisco voucher. The voucher may also permit partial redemption as discussed below with references to FIGS. 6A-6C. The geographical area wide voucher allows the consumer who purchased the geographical area wide voucher to use some/all of the voucher amount at any of the participating approved merchants of the mobile voucher system. To implement the geographic area wide voucher, the mobile voucher system must provide partial redemption (include cents), merchant selection for the approved merchants, real time voucher creation for redemption, consumer email confirmation per amount redeemed and a redemption cap (i.e., consumer cannot redeem more than $10 or $20 worth of stuff per unique redemption and/or merchant.)

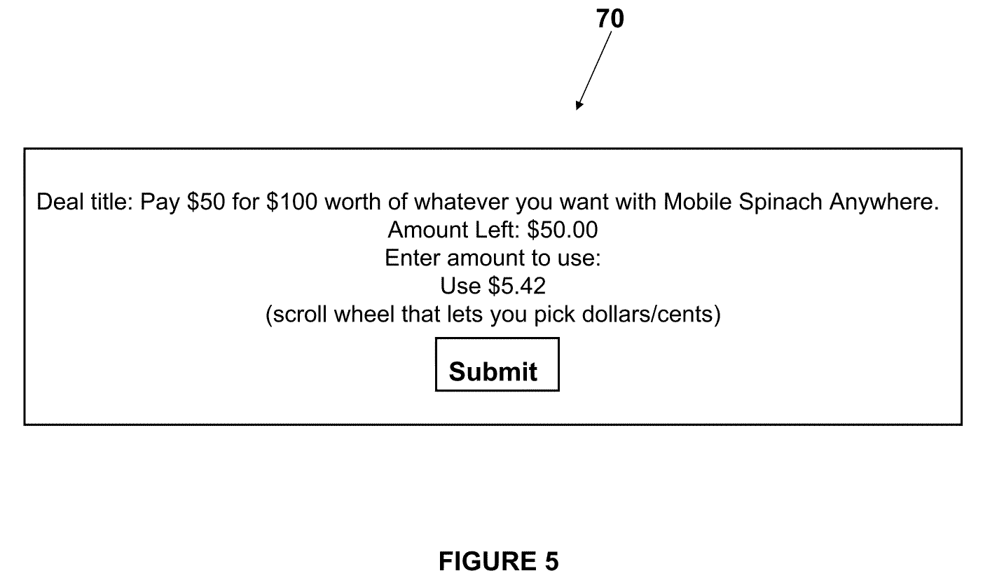

For example, a consumer may purchase a geographic area wide voucher (an example which is shown in FIG. 5) that is $50 for $100 voucher for ‘Mobile Spinach Anywhere’ which resides in their mobile wallet. When the user wants to use the deal to buy coffee and a bagel in the morning (for example the total bill is $5.42), the user operates their device and the mobile voucher system asks for and uses the user's location. Within the mobile voucher user interface, the user can filter merchants by category (for example the user can select dining and optionally the café sub category) or the user can search by merchant name in a free form search box (the mobile voucher system knows the approved merchants in that city, location, and category, and helps fill out the merchant name when user starts to type). For example, the user selects The Bum Café and the figures out how much money they want to use and enters that into the mobile voucher system. The mobile voucher system creates a digital voucher for the user on their smartphone press redeem in the presence of the merchant and the system displays on the smartphone voucher the remaining balance available on the voucher.

FIGS. 6A-6C illustrate another example of the aforementioned partial redemption using the mobile voucher system. As shown, the voucher may have a user interface element that allows the user who purchases the voucher to partially redeem the voucher. In particular, as shown in FIG. 6A, the digital voucher is displayed on a user's device so that the user can redeem the digital voucher. As shown in FIG. 6B, the user interface may provide a mechanism by which the user can select the amount to redeem up to the maximum amount of the voucher and then submit the amount. The user interface may also show the remaining amount of the digital voucher. As shown in FIG. 6C, the amount remaining of the digital voucher after the partial redemption may be shown to the user on the device.

Cross Selling

The mobile voucher system may also provide targeted cross-selling immediately after redeeming another voucher. In particular, the mobile voucher manager 32 of the mobile voucher system may include a cross selling unit (implemented as a plurality lines of computer code executed by the processors of the mobile voucher unit server computers in one embodiment) tracks metrics when a consumer/user redeems a voucher/deal wherein the metrics may include various personal and location specific information about the user along with the merchant category, deal, deal price, redemption amount and redemption time of the previously redeemed deal. The mobile voucher manager 32 then searches the merchant/deal database (stored in the stores 30A-30N) for complimentary already approved deals that are close to the user's current location as specified by their device, in a complimentary categories based on but not limited to the following rule set/algorithm:

An example of the rule set may be (but not limited to the following):
If a user redeems a food deal between the hours of 5 pm and midnight, the complimentary deal should first be a nightclub deal, or for shows/local events if there are no available nightclub deals in the vicinity of the user.
If a user redeems a food deal between the hours of 5 am and 5 pm, the complimentary deal should first be for a café/bakery, then a shopping deal, then a spa/gym deal.
If a user redeems a spa/gym deal at any hour, the complimentary deal should first be for food, then café/bakeries, then shopping, then for shows/events.
If a user redeems a shopping deal at any hour, the complimentary deal should first be for food, then for café/bakeries, then for spas/gyms, then for bars, then for shows/events
If a user redeems a bar deal at any time, the complimentary deal should first be for food, then for shows/events, (then for shopping if it's before 8 pm).
If a user redeems a shows/events deal, the complimentary deal should first be for a bar, then for food, then for café/bakeries, (then for shopping if it's before 8 pm).
If a user redeems a café/bakeries deal, the complimentary deal should first be for shopping, then for shows/events, then for gyms/spas, (then for a bar if it's after 4 pm).

The cross selling of the mobile voucher system may also factor in a user's profile and the user's purchase history along with what they just redeemed to better choose a complimentary deal. The unique personal attributes, preferences, location information and purchase history can also factor into what deals are presented to the user when cross selling occurs. The mobile voucher system would factor in a user's gender and age (if available) and combine that with prior purchase history. So, for example, if the user is female and has frequently purchased health and beauty deals in the past, then if the user redeems a lunch deal in the early afternoon hours on a weekend, the mobile voucher system would then present a spa deal that is in the vicinity of the user.

Proximity Based Pricing

This is a method of pricing goods and services based on the physical proximity or distance a potential consumer is from the good or service or merchant. The mobile voucher system side of this method may be implemented by a proximity pricing unit of the mobile voucher system that may be implemented as a plurality of lines of computer code being executed by the one or more server computers of the mobile voucher system in one embodiment. This relies on using the consumer's GPS enabled device to determine their location and then calculates their physical distance from the merchant(s)/good(s)/service(s). The price offered to the consumer is then determined using an algorithm that has distance as one of the principal determining factors. Prices will be either higher or lower depending on the consumer's distance from the merchant. For example a merchant is attempting to attract 2 consumers. One is 1 block away and one is 10 blocks away. The merchant would have to offer the consumer who is 10 blocks away a greater discount than the one who is only 1 block away since the furthest consumer would have to be offered an extra enticement to travel the further distance.

Time of day will also be a significant factor that will modify the effect that distance has on the price. For example, if a consumer is 1 block away from a coffee shop and it is 8 am, than the discount offered to that consumer may be decreased as it likely that the merchant has enough customers at that time. However, if a consumer is 1 block away from a coffee shop and it is 3 pm, then the discount offered to that consumer may be increased as it is likely that the merchant does not have enough customers at that time.

Additionally, multiple consumers' proximity can be analyzed in real time to determine if a critical mass of consumers with similar interests/profiles is near a targeted merchant. Based on the common profiles of these consumers, the mobile voucher system can offer the consumers a “flash sale” to these consumers in real time by reaching them on their phone all together. We can then drive a “flash mob” or “critical massing” of consumers to the merchant. Additionally, combinations of the above pricing and time factors can apply to these consumers.

In all of the above cases, the mobile voucher system acts as the intermediary between the merchant and the consumer. In some cases the mobile voucher system initiates the sale, in some cases the merchant initiates the sale. In other cases, consumers can initiate the sale by determining if enough similar consumers are nearby. This is a unique combination of location based social networking and location based local deal targeting. Also, in every case, the ability to integrate proximity into pricing is dependent about utilizing the GPS tracking in consumer smart phones. Finally, all of the above can apply to both large and small merchants (big national brands and local brands).

While the foregoing has been with reference to a particular embodiment of the invention, it will be appreciated by those skilled in the art that changes in this embodiment may be made without departing from the principles and spirit of the disclosure, the scope of which is defined by the appended claims.

1. A mobile voucher system, comprising:
one or more consumer computing devices;
a mobile voucher unit that is capable of being connected to and interacting with each of the one or more consumer computing devices over a link;
the mobile voucher unit having a mobile voucher manager that creates a new deal having a purchase price, a redemption value and a discount of the new deal for a particular merchant, that syndicates the new deal to a plurality of consumers to determine a level of interest of the plurality of consumers wherein an interested user participates in the new deal, that presents the new deal to the particular merchant when a deal threshold is met and, when the merchant accepts the new deal, that provides a digital voucher to the consumer computing device of each user who participated in the new deal; and
each consumer computing device that displays the digital voucher received from the mobile voucher unit and that allows the user of the consumer computing device to redeem the digital voucher at the particular merchant and prove an merchant in-store redemption.

2. The system of claim 1, wherein each consumer computing device displays a redeem button user interface to redeem the digital voucher at the particular merchant.

3. The system of claim 1, wherein each consumer computing device determines a position of the consumer computing device and communicates the location information back to the mobile voucher unit to verify that the consumer is near a location of the merchant to validate the in-store redemption.

4. The system of claim 1, wherein the mobile voucher unit pays the merchant when the digital voucher is redeemed.

5. The system of claim 1, wherein the mobile voucher unit pays the merchant a percentage of the digital voucher when the digital voucher is provided to the consumer and then pays a remainder of the digital voucher to the merchant when the digital voucher is redeemed.

6. The system of claim 1, wherein the mobile voucher unit allows a partial redemption of the digital voucher for less than a total amount of the digital voucher.

7. The system of claim 6, wherein each consumer computing device displays a digital voucher user interface with a remaining amount of the digital voucher after a partial redemption.

8. The system of claim 1, wherein the digital voucher is a geographic area wide digital voucher that is redeemable at each approved merchant in the geographic area.

9. The system of claim 8, wherein the geographic area is one of a city and a neighborhood.

10. The system of claim 1, wherein the mobile voucher unit further comprises a cross selling unit that provides a second digital voucher to each consumer computing device for a merchant whose location is close to the location at which a digital voucher is redeemed based on a set of metrics to cross sell the second digital voucher to the user of each consumer computing device.

11. The system of claim 10, wherein the cross selling unit searches a deal store associated with the mobile voucher unit to provide the second digital voucher to each consumer computing device.

12. The system of claim 11, wherein the cross selling unit uses a rule set to provide the second digital voucher to each consumer computing device.

13. The system of claim 1, wherein the mobile voucher unit further comprises a proximity based pricing unit that adjusts a price of the deal for a particular merchant based on a proximity of each consumer computing device to the particular merchant.

14. The system of claim 13, wherein the proximity based pricing unit calculates the distance between each consumer computing device and the particular merchant.

15. The system of claim 13, wherein the proximity based pricing unit adjust the price of the deal for the particular merchant for a particular consumer computing device based on a distance between the particular consumer computing device and the particular merchant.

16. The system of claim 13, wherein the proximity based pricing unit adjust the price of the deal for the particular merchant for a particular consumer computing device based on a time of day.

17. A method for providing a mobile voucher with one or more consumer computing devices and a mobile voucher unit that is capable of being connected to and interacting with each of the one or more consumer computing devices over a link, the method comprising:
creating, using a mobile voucher manager of the mobile voucher unit, a new deal having a purchase price, a redemption value and a discount of the new deal for a particular merchant;
syndicating, using the mobile voucher manager of the mobile voucher unit, the new deal to a plurality of consumers to determine a level of interest of the plurality of consumers wherein an interested user participates in the new deal;
presenting, using the mobile voucher manager of the mobile voucher unit, the new deal to the particular merchant when a deal threshold is met;
providing, using the mobile voucher manager of the mobile voucher unit, when the merchant accepts the new deal, a digital voucher to the consumer computing device of each user who participated in the new deal; and
proving an merchant in-store redemption of the digital voucher by the user of each consumer computing device.

18. The method of claim 17, wherein proving the in-store redemption further comprises displaying, on each consumer computing device, a redeem button user interface to redeem the digital voucher at the particular merchant.

19. The method of claim 17, wherein proving the in-store redemption further comprises determining, on each consumer computing device, a position of the consumer computing device and communicating the location information back to the mobile voucher unit to verify that the consumer is near a location of the merchant to validate the in-store redemption.

20. The method of claim 17 further comprising paying the merchant when the digital voucher is redeemed.

21. The method of claim 17 further comprising paying the merchant a percentage of the digital voucher when the digital voucher is provided to the consumer and then paying a remainder of the digital voucher to the merchant when the digital voucher is redeemed.

22. The method of claim 17, wherein proving the in-store redemption further comprises allowing a partial redemption of the digital voucher for less than a total amount of the digital voucher.

23. The method of claim 22 further comprising displaying, on each consumer computing device, a digital voucher user interface with a remaining amount of the digital voucher after a partial redemption.

24. The method of claim 17, wherein the digital voucher is a geographic area wide digital voucher that is redeemable at each approved merchant in the geographic area.

25. The method of claim 24, wherein the geographic area is one of a city and a neighborhood.

26. The method of claim 17 further comprising providing, by a cross selling unit of the mobile voucher unit, a second digital voucher to each consumer computing device for a merchant whose location is close to the location at which a digital voucher is redeemed based on a set of metrics to cross sell the second digital voucher to the user of each consumer computing device.

27. The method of claim 26, wherein providing the second digital voucher further comprises searching a deal store associated with the mobile voucher unit to provide the second digital voucher to each consumer computing device.

28. The method of claim 27, wherein providing the second digital voucher further comprises using a rule set to provide the second digital voucher to each consumer computing device.

29. The method of claim 17 further comprising adjusting, by a proximity based pricing unit of the mobile voucher unit, a price of the deal for a particular merchant based on a proximity of each consumer computing device to the particular merchant.

30. The method of claim 29, wherein adjusting the price further comprises calculating the distance between each consumer computing device and the particular merchant.

31. The method of claim 29, wherein adjusting the price further comprises adjusting the price of the deal for the particular merchant for a particular consumer computing device based on a distance between the particular consumer computing device and the particular merchant.

32. The method of claim 29, wherein adjusting the price further comprises adjusting the price of the deal for the particular merchant for a particular consumer computing device based on a time of day.

33. A mobile voucher unit that is part of a mobile voucher system that interacts with one or more consumer computing devices, the mobile voucher unit comprising:
a computer system;
a mobile voucher manager executed by the computer system, the mobile voucher manager having a plurality of lines of computer code that perform the processes of:
creating a new deal having a purchase price, a redemption value and a discount of the new deal for a particular merchant, syndicating the new deal to a plurality of consumers to determine a level of interest of the plurality of consumers wherein an interested user participates in the new deal, presenting the new deal to the particular merchant when a deal threshold is met and, when the merchant accepts the new deal, providing a digital voucher to the consumer computing device of each user who participated in the new deal so that each consumer computing device can redeem the digital voucher at the particular merchant and proves an merchant in-store redemption.

34. The unit of claim 33, wherein proving the in-store redemption further comprises determining a location of each consumer computing device to verify that the consumer is near a location of the merchant to validate the in-store redemption.

35. The unit of claim 33 further comprising paying the merchant when the digital voucher is redeemed.

36. The unit of claim 33 further comprising paying the merchant a percentage of the digital voucher when the digital voucher is provided to the consumer and then paying a remainder of the digital voucher to the merchant when the digital voucher is redeemed.

37. The unit of claim 33, wherein proving the in-store redemption further comprises allowing a partial redemption of the digital voucher for less than a total amount of the digital voucher.

38. The unit of claim 33, wherein the digital voucher is a geographic area wide digital voucher that is redeemable at each approved merchant in the geographic area.

39. The unit of claim 38, wherein the geographic area is one of a city and a neighborhood.

40. The unit of claim 33 further comprising providing a second digital voucher to each consumer computing device for a merchant whose location is close to the location at which a digital voucher is redeemed based on a set of metrics to cross sell the second digital voucher to the user of each consumer computing device.

41. The unit of claim 40, wherein providing the second digital voucher further comprises searching a deal store associated with the mobile voucher unit to provide the second digital voucher to each consumer computing device.

42. The unit of claim 41, wherein providing the second digital voucher further comprises using a rule set to provide the second digital voucher to each consumer computing device.

43. The unit of claim 33 further comprising adjusting, by a proximity based pricing unit of the mobile voucher unit, a price of the deal for a particular merchant based on a proximity of each consumer computing device to the particular merchant.

44. The unit of claim 43, wherein adjusting the price further comprises calculating the distance between each consumer computing device and the particular merchant.

45. The unit of claim 43, wherein adjusting the price further comprises adjusting the price of the deal for the particular merchant for a particular consumer computing device based on a distance between the particular consumer computing device and the particular merchant.

46. The unit of claim 43, wherein adjusting the price further comprises adjusting the price of the deal for the particular merchant for a particular consumer computing device based on a time of day.
